(19) United States
(12) Patent Application Publication
(10) Pub. No.: US 2025/0109046 A1
(43) Pub. Date: Apr. 3, 2025

(54) WATER FILTER SYSTEM FOR USE WITH A SHOWER

(71) Applicant: CORE PACIFIC INC., Houston, TX (US)

(72) Inventor: Patrick GWEN, Houston, TX (US)

(21) Appl. No.: 18/479,193

(22) Filed: Oct. 2, 2023

(51) Int. Cl. C02F 1/28; B05B 15/40; C02F 5/08; C02F 101/12

(52) U.S. Cl. CPC C02F 1/283; B05B 15/40; C02F 5/083; C02F 2101/12; C02F 2301/022; C02F 2301/026; C02F 2307/06

(57) ABSTRACT

A water filter system having a first filtering chamber having a first filtering media therein, and a second filtering chamber having a second filtering media therein. The first filtering chamber is adapted to be connected to a water inlet or a water source. The first filtering chamber has a filtered water outlet. The second filtering chamber has an inlet connected to the water outlet of said first filtering chamber. The second filtering chamber has a second filtering media therein. The second filtering chamber has a filtered water outlet at an end opposite the first filtering chamber. The second filtering chamber is connectable to a showerhead.

### FIELD OF THE INVENTION

The present invention relates to water filters for use with showers. More particularly, the present invention relates to water filters that can be attached to a hose extending to a showerhead. More particularly, the present invention relates to water filters for use with showers that effectively remove particulates, contaminants and scalants from the water delivered from the showerhead.

### BACKGROUND OF THE INVENTION

Various devices and systems have been used to treat water used in domestic water systems. Potable water commonly includes contaminants and chemicals, such as chlorine, which kills bacteria in the water. Currently, approximately 80% of all potable water systems in the United States utilize chlorine as a disinfectant. However, while serving a positive function of eliminating bacteria and the like, chlorine may be undesirable in drinking water and can have a harmful effect on human skin and hair. Consequently, it is generally preferable to remove chlorine from drinking water and shower/bath water.

Another characteristic of many potable water systems, particularly water in areas that draw water from certain rivers, is a high mineral content. High mineral content contributes to water hardness. Hardness is typically undesirable in domestic water systems, insofar as it commonly contributes to scaling on glass surfaces, and makes water more difficult to lather, requiring greater amounts of soap, shampoo or the like for showering/bathing.

Various types of domestic water systems have been used to filter or treat water. Whole house systems, also referred to as point-of-entry systems, treat the water as it enters the house, e.g. to filter or soften all of the water flowing into the house. Point-of-use devices, such as shower filters, kitchen sink filters, or refrigerator filters, treat the water at a specific location of the house where the water is used.

Whole house systems are generally effective to remove chemicals or modify water characteristics throughout the house water system. However, while such filtering or treatment may be useful for many uses of water, it may be undesirable for other uses. For example, although chlorine removal may be useful for treating shower water or drinking water, it may not be useful or desirable in relation to removing chlorine from toilet water, sink water, or swimming pool water. Further, chlorine removal may facilitate the growth of bacteria or algae within toilets or plumbing. In some cases, the algae can contribute to clogging of shower fixtures and other bacteria conditions in water dispensers.

Whole house water softeners are useful to lower the mineral content of shower water or drinking water. However, many such systems utilize salt to remove the calcium content. This introduces a substantial salt content in the water. That can be undesirable for various water uses, such as watering plants, and can cause difficulties in municipal water treatment systems. Accordingly, such whole house systems and point-of-use systems each have advantages and disadvantages associated with the different uses of domestic water, e.g. drinking water, shower/bath water, toilet water, pool water, landscape water etc.

Point-of-use filtration systems address some of the deficiencies of the whole house systems and allow selective filtration, to suit the various uses of domestic water. For example, shower filters, kitchen sink filters, and refrigerator filters are useful to remove chlorine from the water at the point-of-use, while retaining chlorine in the water system to serve as an antibacterial additive in the toilet water in pool water, and to mitigate the growth of bacteria and algae in the house plumbing.

Shower filtering devices have become increasingly popular and have been implemented in a variety of ways. In-line filters are commonly installed intermediate the shower arm and the showerhead. One such device is the High Output shower filter, marketed by Sprite Industries, Inc. Shower heads have been made to incorporate an internal shower filter, allowing for a more compact arrangement. One such combination showerhead/water filter is the Deluxe 8 All-In-One marketed by Sprite Industries, Inc.

Shower filters have also been introduced into handheld shower wands, to provide a device which incorporates the convenience of the shower wand, with the added functionality of the water filter. One such device is the Shower Falls shower wand marketed by Sprite Industries, Inc. In one implementation, the filtering media used in such shower wands is contained within a replaceable cartridge insertable in the handle. In another construction, the filtering unit is a permanent portion of the handle, and the filtering unit is replaced by detaching and replacing the handle.

One limitation of such filtered shower wands concerns the weight of the filter media, which is typically a mixture of copper and zinc. The weight of the shower handle may make it difficult to disconnect the handle from the showerhead or the hose, both of which are commonly engaged to the handle by engagement of mating threaded portions. The weight of the handle, space limitations within a shower stall, and the lack of protective clothing and footwear frequently worn during the process, contribute to injury or damage when the filtered element is being replaced. More specifically, as one hand holds the showerhead, the other hand may progressively twist and release the handle from the showerhead to the point that the handle may disengage from the showerhead when it is not firmly in the grasp of the user, falling on the shower floor or the foot of the user, with considerable force.

Studies are now beginning to show that humans can consume large amounts of chlorine in the shower. Chlorine, by nature, is a gas. In the form of a hot water spray, such as a shower, the chlorine is highly unstable and almost instantly converts to a gas. The person taking a shower then inhales this chlorine gas. One study asserts that chlorine inhaled in one shower is equivalent to drinking fifty gallons of chlorinated tap water. It is not known how harmful the inhalation of this chlorine gas can be. As such, there is a concern among health-conscious consumers that the intake of any chlorine could be harmful.

Another problem with shower water is scale in the water, also known as “hard water”. Scale or hard water are layman's terms for the presence of calcium and magnesium. These two common ingredients are present in 75% of all American households' tapwater. Scale is harmless to our health, but aesthetically unpleasing. Typically, hard water or scale forms a white crust around the spray holes in the showerhead, causing the showerhead to degrade over time. The scale is also unsightly when it sticks to surfaces, such as shower walls or doors. Even ceramic tile is not immune to the build-up of scale. Scale is a particular problem on walls since it provides a surface area for the growth of bacteria. The combination of a moist environment and the rough surface of a scaly tiled wall is perfect for bacteria and algae growth. Today, most bathroom cleansers will assert that they attack or remove scale deposits as well as clean, but these remedies are only partly effective.

Another problem was shower water is fine sediment. Tap water, such as municipally-treated water or well water, typically has fine sediment which is often invisible. This will, over time, clog a water filter and thus reduce the flow of water through the filter prematurely.

Therefore, there is a need for a device that effectively removes chlorine from tap water such as shower or bath water, that also treats the components of the water stream that cause scale deposits. There is also a need for a device that effectively removes fine sediment from tap water so that the device does not clog prematurely and does not reduce the flow of water through the device. There is also a need for an economical shower filter device that can be adapted to a wide variety of plumbing and shower configurations.

Various patents have issued, in the past, for filters that filter shower water. For example, U.S. Pat. No. 5,152,464, issued on Oct. 6, 1992 to F. A. Farley describes a shower filter assembly having a thin or low-profile design. The shower filter assembly includes a recessed inlet which leads to an internal chamber in which a baffle is mounted to deflect water flowing into the chamber substantially evenly through dechlorinated media held within the chamber. An outlet from the chamber includes a shut-off valve and a compact showerhead securely mounted to the end of the outlet.

U.S. Pat. No. 5,549,822, issued on Aug. 27, 1996 to G. E. Ferguson, teaches a water purification filtered coupled intermediate a conventional showerhead feed pipe and showerhead. The filtration device is toroidal with a serpentine flow path. The filtration device envelops the feed pipe which enables the showerhead to remain within substantially the same location as before the insertion of the filter. The filter contains a filter media coupled between a pair of filter screens in order to purify the shower water.

U.S. Pat. No. 6,016,977, issued on Jan. 25, 2000 to D. K. Farley, discloses a hand-held showerhead and filter assembly for attachment to a water line in order to remove chlorine and other substances from water. This assembly includes a reversible and reusable filter assembly for use with hot water passing through a two-stage bed of ceramic-type calcium sulfide beads and a copper/zinc material. The device includes an elongated, hollow handle which holds the filter element therein in such a manner that the filter media reacts with or removes chlorine and other substances more efficiently from shower water. This allows a greater volume of water to be treated.

U.S. Pat. No. 6,267,887, issued on Jul. 31, 2001 to Hughes et al., describes a shower filter for chlorine removal and scale deposit prevention. This shower filter includes a filter cartridge including a carbon block for chlorine removal and a scale-inhibitor media contained in a space within the carbon block. The filter cartridges are adapted for use in the shower/tub filter units. The filter cartridge is asymmetrical and bi-directional and has aperatured end caps on each end of the filter cartridge such that it can be inserted into the filter housing with either end in an upward orientation.

U.S. Pat. No. 10,737,203, issued on Aug. 11, 2020 to D. K. Farley, provides a compact shower water filter assembly for holding a water filter element therein. The water filter element is easily changeable by unscrewing two halves of the body forming the filter assembly. The body halves are easily gripped and turned so as to be opened or closed. The upper half of the body is internally threaded to engage the shower arm and can pivot about the shower arm. The bottom half of the water filter assembly can include a showerhead.

U.S. Patent Application Publication No. 2002/0179515, published on Dec. 5, 2002 to D. K. Farley, teaches a combination hand-held shower head and water filter assembly for removing chlorine and other substances from hot shower water. The assembly includes an elongated filter housing with an elongated showerhead pivotally secured thereto by an extended swivel-and-ball arrangement. The elongated filter housing holds filter media therein.

U.S. Patent Application Publication No. 2008/0011656, published on Jan. 17, 2008 to Lacy et al., provides a shower filter apparatus to neutralize chlorine from water using water-soluble vitamin C in the form of ascorbic acid and sodium ascorbate, the vitamin E in the form of tocopheryl acetate to prevent the oxidation of the vitamin C, a cylindrical threaded sealed cartridge system with media feed apertures to control delivery of the best vitamin solution, a gasketed flow control device that creates a positive water-tight seal over the media feed apertures when the device is not in use, and a transparent observation window within the media cartridge.

U.S. Patent Application Publication No. 2013/0319929, published on Dec. 5, 2013 to D. A. Farley, teaches a shower filter that comprises a cap having an input port connectable to a shower arm and an output port connectable to a showerhead. A filter assembly is engageable to and supported by the cap. A housing is disposed about the filter assembly and is engageable with the cap. The housing is engageable with the filter assembly as the filter assembly remains engaged with the cap. The filter assembly further includes a fluid dispersal chamber, input flow path, and an output flow path. The fluid dispersal chamber facilitates distribution of water from the filter assembly's input flow path throughout the output flow path.

U.S. Patent Application Publication No. 2015/0076254, published in Mar. 19, 2015 to D. A. Farley, shows a hand-held, filtered shower wand that includes a spray head and a handle. The handle defines a handle body with input and output ports. The handle also includes a filter media canister. The output port includes a first twist-lock connector. The spray head has a second twist-lock connector. The first and second twist-lock connectors are engageable to form a seal between the connectors. An O-ring between the connectors provides a watertight seal. The filter media canister may be accessed and replaceable by simple twist of the connectors. It is an object of the present invention to provide a shower filter which minimizes pressure loss throughout the filter system.

It is an object of the present invention to provide a shower filter which minimizes pressure loss throughout the filter system.

It is another object of the present invention to provide a shower filter system that creates a laminar flow of water through the filter.

It is another object of the present invention to provide a shower filter system that filters all of the water passing through the filter.

It is another object of the present invention to provide a shower filter system that enhances the velocity of the water flow through the filter system.

It is another object of the present invention to provide a shower filter that removes the contaminants, chlorines and scale from the shower water.

It is another object of the present invention to provide a shower filter system that reduces the weight of the filter system from the showerhead or nozzle.

It is still another object of the present invention to provide a shower filter system which is compact.

It is a further object of the present invention to provide a shower filter system that maximizes contact between the tap water and the filter media.

It is still another object of the present invention to provide a shower filter system that is aesthetically pleasing.

These and other objects and advantages of the present invention will become apparent from a reading of the attached specification and appended claims.

### BRIEF SUMMARY OF THE INVENTION

The present invention is a water filter system that has a first filtering chamber and a second filtering chamber in communication with the first filtering chamber. The first filtering chamber has a first filtering media therein. The first filtering chamber is adapted to be attached to a water inlet or a water source. The first filtering chamber has a filtered water outlet. The second filtering chamber has a second filtering media therein. The second filtering chamber as an inlet connected to the water outlet of the first filtering chamber. The second filtering chamber has a second filtering media therein. A filtered water outlet is on a side of the second filtering chamber opposite the first filtering chamber.

The first filtering chamber is adapted to connect to a water source. The second filtering chamber is connected to a showerhead. The first filtering chamber has an elongated shape with a length dimension of between 50 and 250 millimeters and a diameter between 20 and 60 millimeters. In the preferred embodiment the present invention, the first filtering media can be charcoal or activated carbon. The second filtering meter can be an anti-sealant such as calcium sulfate, calcium carbonate, barium sulfate, silica, calcium fluoride, strontium sulfate and alumina. The second filtering chamber has a generally circular shape. The inlet of the second filtering chamber is positioned opposite the water outlet of the second filtering chamber around a diameter of the circular shape of the second filtering chamber.

The first filtering chamber comprises an elongate housing having a length dimension that is greater than the diameter or width of the elongate housing. A first funnel-shaped chamber is positioned in the elongate housing. This first funnel-shaped chamber has a wide diameter end and a narrow diameter end opposite the wide diameter end. The elongate housing as an inlet opening to the wide diameter end of the first funnel-shaped chamber. The first filtering media is positioned at an interior of the first funnel-shaped chamber and in the elongate housing exterior of the first funnel-shaped chamber. The first funnel-shaped chamber has a plurality of holes formed through a wall thereof. The plurality of holes open to an interior of the first funnel-shaped housing and to an exterior of the first funnel-shaped housing. The plurality of holes cause a portion of the water flow from the water inlet to enter the interior of the elongate housing exterior of the first funnel-shaped chamber.

A second funnel-shaped chamber is positioned in end-to-end relationship to the first funnel-shaped chamber. The second funnel-shaped chamber has a wide end opening to a narrow diameter end of the first funnel-shaped chamber. The filtered water outlet is at a narrow diameter end of the second funnel-shaped chamber. The first filter media is positioned in an interior of the second funnel-shaped chamber and in the elongate chamber exterior of the second funnel-shaped chamber.

The second filtering chamber comprises a housing having an interior volume. The second filtering media is received in the interior volume of the housing. A first baffle is positioned in the interior volume of the housing. This first baffle defines a circuitous flow path of the filtered water through the interior volume of the housing. A second baffle is positioned in the interior volume of the housing. The second baffle is separated by a wall from the first baffle. The wall has a channel therein that causes the filtered water from the first baffle to enter the second baffle.

In the present invention, a first hose connects an inlet of the first filtering chamber to the water inlet or water source. A second hose connects the filtered water outlet of the second filtering chamber to the showerhead.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a perspective view showing a showerhead and water source to which the shower filter of the present invention is applied.

FIG. 2 is a side elevational view of the shower filter in accordance with the preferred embodiment of the present invention.

FIG. 3 is a side cross-sectional view of the shower filter of the present invention.

FIG. 4 is an upper perspective view showing the second filtering chamber of the shower filter of the present invention.

FIG. 5 is a cross-sectional view of the second filtering chamber of the showerhead of the present invention.

FIG. 6 is an upper perspective exploded view of the second filtering chamber of the shower filter of the present invention.

### DETAILED DESCRIPTION OF THE INVENTION

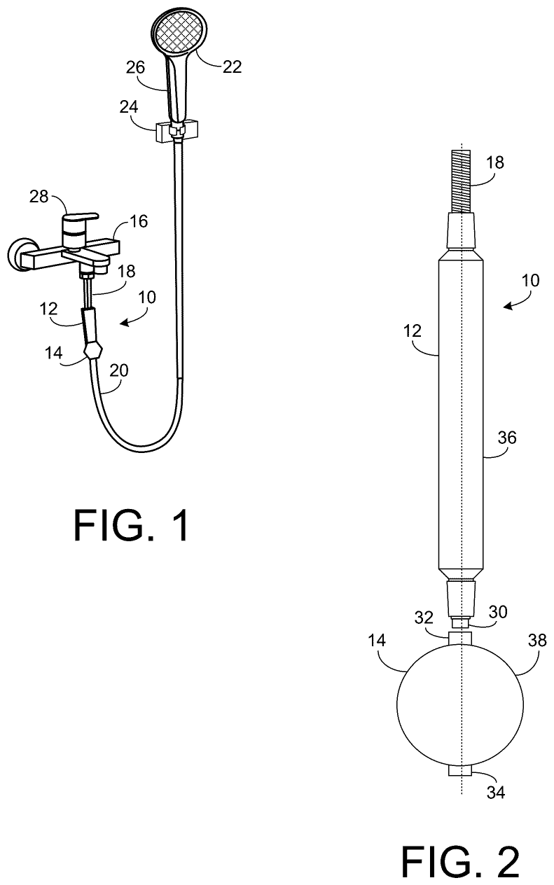

Referring to FIG. 1, there is shown the shower filter system 10 in accordance with the preferred embodiment the present invention. The shower filter system 10 includes a first filtering chamber 12 and a second filtering chamber 14. The shower filter system 10 of the present invention is illustrated as being applied to a water inlet or water source 16. The water source 16 can be in the nature of a faucet. A first hose 18 extends from the water source 16 and connects with a water inlet of the first filtering chamber 12. The second filtering chamber 14 is connected to a second hose 20. The second filtering chamber 14 has an outlet that delivers the filtered water into the second hose 20. The second hose 20 has a showerhead 22 at an opposite end thereof. The showerhead 22 can be retained in a proper position within a shower by a bracket 24.

FIG. 1 shows merely one configuration of shower water source and showerhead to which the shower filter system 10 can be applied. In certain circumstances, the first hose 18 could be connected to a water pipe that extends to the showerhead. As such, the first hose 18, the shower filter system 10 and the second hose 20 will simply drape from the water pipe extending from the fixed showerhead. In preferred embodiment present invention, the shower filter system 10 is applied to hoses that can be connected to a handheld showerhead 22. As such, the user can use the showerhead 22 in a fixed location (as supported by bracket 24), or the user can simply grasp the handle 26 of the showerhead 22 and move the showerhead 22 to any position suitable for cleaning and showering.

An important feature of the present invention is that the shower filter system 10 is located adjacent to the water source 16. As such, the filtering components associated with the shower filter system 10 do not need to be supported by the hands and arms of the user nor do they need to be supported by the bracket 24. As such, the weight of the showerhead is relatively minimal. The vast weight of the shower filter system 10 is supported by its connection with the water source 16. In the case shown in FIG. 1, the faucet 28 bears the load of the weight of the shower filter system 10, along with the weight of the first hose 18 and the second hose 20. The shower filter system 10, being located below the faucet 28, is in an extremely convenient position such that users can easily replace the filtering elements within the shower filter system 10 or otherwise modify or repair the first filtering chamber 12 or the second filtering chamber 14.

FIG. 2 illustrates the shower filter system 10 of the present invention. Shower filter system 10 includes a the first filtering chamber 12 and the second filtering chamber 14. The first filtering chamber 12 will have a first filtering media therein. The first filtering chamber 12 is adapted to be connected to the water inlet, such as hose 18 or to a water source, such as faucet 16. The first filtering chamber 12 has a filtered water outlet 30 opposite the water inlet 18. The second filtering chamber 14 will have a second filtering media therein. The second filtering chamber 14 has an inlet 32 connected to the water outlet 30 of the first filtering chamber 12. The second filtering chamber 14 has a filtered water outlet 34 at an end opposite the inlet 32 or the first filtering chamber 12. The outlet 34 of the second filtering chamber 14 is adapted to be connected to the second hose 20 and ultimately in communication with the showerhead 22.

The first filtering chamber 12 has an elongate housing 36 with a length dimension of between 50 and 250 millimeters and a diameter between 20 and 60 millimeters. In a preferred embodiment of the present invention, the first filtering media within the elongate housing 36 of the first filtering chamber 12 will be charcoal or activated carbon. The second filtering media within the interior of the second filtering chamber 14 is an anti-scalant such as calcium sulfate, calcium carbonate, barium sulfate, silica, calcium fluoride, strontium sulfate and alumina.

The second filtering chamber 14 has a generally circular or round housing 38. The inlet 32 of the second filtering chamber 14 is positioned opposite the filtered water outlet 34 of the second filtering chamber 14 around a diameter of the circular shape of the second filtering chamber 14.

The elongate housing 36 of the first filtering chamber 12 has a length of between 50 and 250 millimeters and a diameter between 20 and 60 millimeters. This configuration allows a suitable amount of residence time for the water from the water source 16 to enter and interact with the first filtering media in the interior of the elongate housing 36. A narrower elongate housing 36 or shorter elongate housing 36 would generally provide inadequate amount of residence time in order for the first filtering media (being charcoal or activated carbon) to sufficiently interact with the inlet water so as to remove the chlorine from the inlet water and remove other matter and chemicals from the inlet water. Additionally, the relatively long length and narrow diameter of the elongate housing 36 of the first filtering chamber 12 presents as a relatively attractive appearance for the shower filter system 10. Since the elongate housing 36 has a relatively narrow diameter or width, it is extremely easy to grasp with human hands. As such, hand installation of the shower filter system 10 can be accomplished in a quick and easy manner without the use of tools. This relatively large length-to-diameter ratio of the elongate housing 36 also significantly reduces the overall weight of the shower filter system 10.

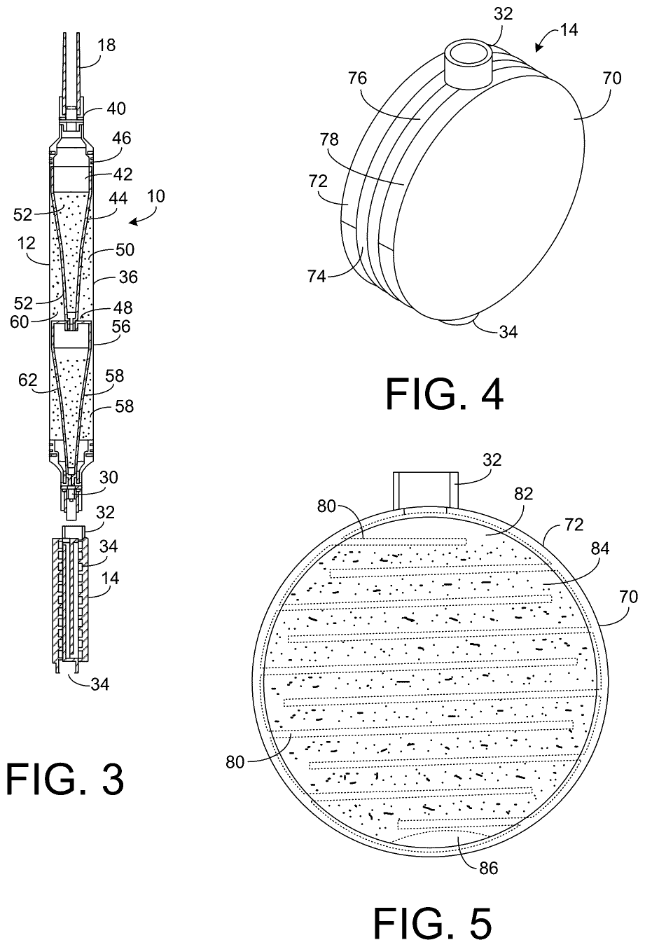

In order to improve pressure and flow characteristics of the water entering the water inlet of the first filtering chamber 12, the first filtering chamber 12 has a unique interior configuration. This is particularly illustrated in FIG. 3. In FIG. 3, it can be seen that the shower filter system 10 includes the first filtering chamber 12 and the second filtering chamber 14. The inlet 40 of the first filtering chamber 12 is connected to the first hose 18 in a conventional manner (such as a threaded connection, a bolted connection, a clamp connection, or similar means). Water passing through the first hose 18 will enter the inlet 40 and enter the interior 42 of the elongate housing 36 of the first filtering chamber 12. A first funnel-shaped chamber 44 is positioned in the elongate housing 36. The first funnel-shaped chamber 42 has a wide diameter end 46 and a narrow diameter end 48 opposite the wide diameter end 46. The inlet 40 of the elongate housing 36 opens to the wide diameter end 46 of the first funnel-shaped chamber 44. The first filtering media 50 is positioned in the interior 42 of the first funnel-shaped chamber 44 and in the elongate housing 36 exterior of the first funnel-shaped chamber 44. The first funnel-shaped chamber 44 has a plurality of holes 52 formed through a wall thereof. The plurality of holes 52 open to the interior 42 of the first funnel-shaped housing 44. These holes 52 also open to the exterior of the first funnel-shaped chamber 44. The plurality of holes 52 because a portion of the water from the water inlet 40 to enter the interior of the elongate housing 36 exterior of the first funnel-shaped chamber 44.

Importantly, in FIG. 3, can be seen that when the water from the water source (such as faucet 28) passes through the first hose 18 and into the inlet 40 of the first filtering chamber 12, it will flow into the wide end 46 of the first funnel-shaped chamber 44. The walls of the first funnel-shaped chamber 44 will narrow as the water passes therethrough. This will exert a venturi effect on the flow of liquid and also create a laminar flow of the water through the interior 42 of the elongate housing 36. As such, the flow rate and the pressure of the water is maintained even as it is being filtered by the filter media 50. A small portion of the water flowing through the interior of the first funnel-shaped chamber 44 will pass through holes 52 and into the interior of the elongate housing 36 exterior of the first funnel-shaped chamber 44. Once again, this small portion of the water will interact with the first filter media 50. This creates a long amount of residence time between the first filter media 50 and the water from the water source that enters the interior of the shower filter system 10.

Ultimately, the water that flows outwardly of the narrow diameter end 48 of the first funnel-shaped chamber 44 will flow into a wide end 56 of a second funnel-shaped chamber 58. The water that is mixed with the filter media 50 on the exterior of the first funnel-shaped chamber 44 can flow through openings in plate 60 so as to also flow into the wide diameter end 56 of the second funnel-shaped chamber 58. Once again, this water will mix with the first filter media 50 in the interior of the second funnel-shaped chamber 58 and in the interior of the elongate housing 36 on the exterior of the second funnel-shaped chamber 58. Ultimately, the holes 62 allow a small portion of the water flowing into the second funnel-shaped chamber 58 to move into the interior of the elongate housing 36 on the exterior of the second funnel-shaped chamber 58. Both the water flowing through the interior of the second funnel-shaped chamber 58 and the water flowing through the interior of the elongate housing 36 on the exterior of the second funnel-shaped chamber 58 will ultimately flow downwardly so as to pass outwardly of the first filtering chamber 12 by way of outlet 30.

The configuration of the first funnel-shaped chamber 44 and the second funnel-shaped chamber 58 enhances the flow characteristics of the water through the interior of the first filtering chamber 12. As such, as filtered water exits the outlet 30, it will be of a relatively high pressure and high flow rate. The use of the first funnel-shaped chamber 44 and the second funnel-shaped chamber 58 enhances the residence time of the water from the water source with the filtering media on the interior of the first filtering chamber 12. As such, the present invention assures that a properly filtered water passes outwardly of the outlet 30 of the first filtering chamber 12. The present invention achieves complete filtering with the first filtering media 50, maintains fluid pressure and enhances the flow rate of the fluid through the interior of the first filtering chamber 12. The laminar flow of water and the venturi effect created upon this laminar flow of water within the interior of the first filtering chamber 12 turns the turbulent water from the first hose 18 from the water source and into the inlet 40 into a laminar flow of water. This improves flow characteristics and mixing characteristics between the water and the filtering media.

Since the elongate housing 36 of the first filtering chamber 12 has a particular type of filter media 50 on the interior thereof (such as charcoal or activated carbon), the user may desire to further filter the filtered water from the filtered water outlet 30 of the first filtering chamber 12. As such, the second filtering chamber 40 is positioned so that its inlet 32 is engaged in fluid-tight relationship with the outlet 30 of the first filtering chamber 12. As will be described hereinafter, the second filtering chamber 14 has a plurality of internal passageways 64 which allows the filtered water passing from the filtered water outlet 30 of the first filtering chamber 12 to intimately mix with the second filtering media on the interior of the second filtering chamber 40. Ultimately, the filtered water can pass outwardly of the second filtering chamber 14 through the outlet 34. In the preferred embodiment of the present invention, the filtering media used in the second filtering chamber 14 can an anti-scalant such as calcium sulfate, calcium carbonate, barium sulfate, silica, calcium fluoride, strontium sulfate and alumina. In this manner, the shower filter system 10 of the present invention provides a dual filtering configuration so that very pure, particulate-free, chlorine-free, and scalant-free water exits the outlet 34 of the second filtering chamber 44 and passes into the second hose 20 toward the showerhead 22.

FIG. 4 is a perspective view showing the second filtering chamber 14. The second filtering chamber 14 includes a housing 70 having an interior volume. The second filtering media will be received in the interior volume of the housing 70. The inlet 32 will open to the interior volume of the housing 70. The outlet 34 is positioned opposite the inlet 32 around the circumference of the circular housing 70. It can be seen that the housing 70 is made up of several panels 72, 74, 76 and 78. As will be described hereinafter, panels 72 and 78 will have the baffles formed therein or connected thereto. These baffles on the panels 72 and 78 will serve to create a circuitous flow of the filtered water through the interior of the housing 70. Panels 74 and 76 will enclose the baffles of the panels 72 and 78, respectively. Each of the panels 74 and 76 can include a channel located along a periphery thereof. This channel will allow the filtered water flowing along the baffles of the first panel 72 to exit therefrom and enter the baffles of the panel 78. Ultimately, after treatment, the treated water from the interior of the housing 70 will exit through the outlet 34.

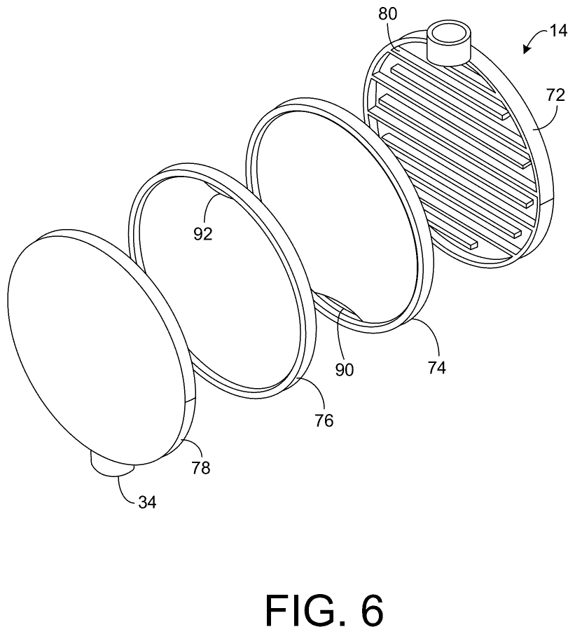

FIG. 5 shows the panel 72 of housing 70. It can be seen that the panel 72 has a plurality of plates 80 that are arranged in parallel planar relationship with gaps 82 formed adjacent the inner wall of the panel 72. The second filtering media 84 will fill the interior of the baffles 80 of the second filtering chamber 70. As such, those water flows from the inlet 32 through the interior of the second filtering chamber 70, it will intimately mix with the second filtering media 84 so that the anti-scalant effects can be accomplished. Ultimately, the filtered anti-scaled water can exit through a channel 86 located at the periphery of the plate 72.

It should be noted that this circuitous flow of water through the baffles 80 of the second filtering chamber 14 causes a proper amount of residence time between the filtered water and the anti-scalant within the interior of the housing 70. It also creates intimate mixing between the anti-scalant and the filtered water. As such, this enhances the anti-scalant and effects of the filtering system 10 of the present invention. This is carried out without any loss of pressure or flow rate. The water will enter the inlet 32 of the second filtering chamber 14, pass through the baffles 80, and exit through the outlet 34 at approximately the same flow rate as the filtered water exiting the outlet 30 of the first filtering chamber 12.

FIG. 6 shows an exploded configuration of the second filtering chamber 14 of the present invention. In particular, panel 72 is illustrated as having baffles 80 configured on an interior thereof. Panel 78 will have a similar arrangement of baffles 80 on the interior thereof (not illustrated). Panels 74 and 76 will cover the baffles on the respective panels 72 and 78. The panel 74 includes a channel 90 at the bottom thereof. Channel 90 will cause the anti-scaled water exiting the baffles 80 of the first panel 72 to flow outwardly thereof and flow between the panels 74 and 76 and exit outwardly through the channel 92 located at the top of the panel 76. The anti-scaled water can then flow downwardly through the baffles located on the panel 78 and ultimately exit the second filtering chamber 14 at the outlet 34. This configuration always assures that there is a proper gravity flow of the water through the baffles in combination with the water pressure and flow rate. This enhances the flow characteristics of the water exiting the baffles of the plate 78 and exiting the second filtering chamber 14 through the outlet 34.

Within the concept of the present invention, the shower filter system 10 of the present invention can include a single first filtering chamber 12 (with its internal structures) or can have a single second filtering chamber 14 (with its internal structures). The connected first filtering chamber 12 and the second filtering chamber 14 is an example of how these filtering chambers can be combined so as to have a complete and full filtering effect upon the shower water. As such, the user is able to wash themselves with clean, pure water that is free of chlorine and scalants.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

I claim:

1. A water filter system comprising:
a first filtering chamber having a first filtering media therein, said first filtering chamber adapted to be attached to a water inlet or a water source, said first filtering chamber having a filtered water outlet; and
a second filtering chamber having a second filtering media therein, said second filtering chamber having an inlet connected to the filtered water outlet of said first filtering chamber, said second filtering chamber having a second filtering media therein, said second filtering chamber having a filtered water outlet at an end opposite said first filtering chamber.

2. The water filter system of claim 1, said first filtering chamber adapted to connect to the water source, said second filtering chamber being connected to a showerhead.

3. The water filter system of claim 1, said first filtering chamber having an elongate shape with a length dimension of between 50 and 250 millimeters and a diameter of between 20 and 60 millimeters.

4. The water filter system of claim 1, wherein the first filter media is charcoal or activated carbon, the second filter media being an anti-scalant selected from the group consisting of calcium sulfate, calcium carbonate, barium sulfate, silica, calcium chloride, strontium sulfate and alumina.

5. The water filter system of claim 1, said second filtering chamber having a generally circular shape, the inlet of said second filtering chamber being positioned opposite the water outlet of said second filtering chamber around a diameter of the generally circular shape of said second filtering chamber.

6. The water filter system of claim 1, wherein said first filtering chamber comprises:
an elongate housing having a length dimension that is greater than a diameter or width dimension of said elongate housing; and
a first funnel-shaped chamber positioned in said elongate housing, said first funnel-shaped chamber having a wide diameter end and a narrow diameter end opposite the wide diameter end, said elongate housing having an inlet opening to the wide diameter end of said first funnel-shaped chamber.

7. The water filter system of claim 6, the first filter media being positioned in an interior of said first funnel-shaped chamber and in said elongate housing exterior of said first funnel-shaped chamber.

8. The water filter system of claim 7, said first funnel-shaped housing having a plurality of holes formed through a wall thereof, said plurality of holes opening to an interior of said first funnel-shaped chamber and to the exterior of said first funnel-shaped chamber, the plurality of holes causing a portion of the water from the water inlet to enter the interior of said elongate housing exterior of said first funnel-shaped chamber.

9. The water filter system of claim 6, further comprising:
a second funnel-shaped chamber positioned in end-to-end relationship with said first funnel-shaped chamber, said second funnel-shaped chamber having a wide end opening to the narrow diameter end of said first funnel-shaped chamber, wherein the filtered water outlet is at a narrow diameter end of said second funnel-shaped chamber.

10. The water filter system of claim 9, wherein the first filter media is positioned in a interior of said second funnel-shaped chamber and in said elongate chamber exterior of said second funnel-shaped chamber.

11. The water filter system of claim 1, wherein said second filtering chamber comprises:
a housing having an interior volume, the second filtering media received in the interior volume of said housing; and
a first baffle positioned in the interior volume of said housing, said first baffle defining a circuitous flow path of the filtered water through the interior volume of said housing.

12. The water filter system of claim 11, further comprising:
a second baffle positioned in the interior volume of said housing, said second baffle being separated by wall from said first baffle, the wall having a channel therein that causes the filtered water from the first baffle to enter the second baffle.

13. The water filter system of claim 1, further comprising:
a first hose connecting an inlet of said first filtering chamber to the water outlet; and
a second hose connecting the filtered water outlet of said second filtering chamber to a showerhead.

14. A water filter for a shower, the water filter comprising:
an elongate housing having a length dimension greater than a diameter or width dimension of said elongate housing, said elongate housing having an inlet at one end thereof, the inlet of said elongate housing adapted be connected to a water inlet or a water source;
a first funnel-shaped chamber positioned in said elongate housing, said first funnel-shaped chamber having a wide end and a narrow end opposite the wide end, the wide end of said first funnel-shaped chamber opening to the inlet of said elongate housing; and
a filter media received in an interior of said first funnel-shaped chamber and an interior of said elongate housing exterior of said first funnel-shaped chamber, said elongate housing having an outlet at the narrow end of said first funnel-shaped chamber having an outlet communicating with the narrow end of said first funnel-shaped chamber.

15. The water filter of claim 14, said first funnel-shaped chamber having a plurality of holes formed through a wall thereof, said plurality of holes opening to an interior of said first funnel-shaped chamber and to the exterior of said first funnel-shaped chamber, the plurality of holes causing a portion of the water from the water inlet to enter the interior of said elongate housing exterior of said first funnel-shaped chamber.

16. The water filter of claim 14, further comprising:
a second funnel-shaped chamber positioned in end-to-end relationship with said first funnel-shaped chamber and positioned within the interior of said elongate housing, said second funnel-shaped chamber having a wide end opening to the narrow end of said first funnel-shaped chamber, wherein the filtered water outlet is at the narrow end of said second funnel-shaped chamber.

17. The water filter of claim 14, further comprising:
a housing having another filtering media therein, said housing having an inlet connected to the outlet of said elongate housing, said housing having an outlet opposite the inlet of said housing, the another filter media being different than the filter media received in the interior of said first funnel-shaped chamber.

18. A water filter for a shower, the water filter comprising:
a housing having an interior volume, the housing having an inlet and an outlet;
a filter media received in the interior volume of said housing; and
a first baffle positioned in the interior volume of said housing, said first baffle defining a circuitous flow path of water through the filter media in the interior volume of said housing.

19. The water filter of claim 18, further comprising:
a second baffle positioned in the interior volume of said housing, said second baffle being separated by wall from said first baffle, the wall having a channel therein that allows the filtered water from the first baffle to enter the second baffle.

20. The water filter of claim 18, further comprising:
an elongate housing having a length dimension greater than a diameter or width dimension of said elongate housing, said elongate housing having an inlet at one end thereof, the inlet of said elongate housing adapted to be connected to a water inlet or water source;
a first funnel-shaped chamber positioned in said elongate housing, said first funnel-shaped chamber having a wide end and a narrow end opposite the wide end, the wide end of said first funnel-shaped chamber opening to the inlet of said elongate housing; and
another filter media received in an interior of said first funnel-shaped chamber and an interior of said elongate housing exterior of said first funnel-shaped chamber, said elongate housing having an outlet at a narrow end of said first funnel-shaped chamber, the outlet of said elongate housing communicating with the inlet of the housing.
